(19) United States
(12) Patent Application Publication
(10) Pub. No.: US 2026/0141709 A1
(43) Pub. Date: May 21, 2026

(54) DEVICE AND METHOD FOR DETECTING FISH AT DIFFERENT STAGES OF DEVELOPMENT USING A MACHINE LEARNING MODEL

(71) Applicants: BOARD OF REGENTS, THE UNIVERSITY OF TEXAS SYSTEM, Austin, TX (US); THE UNITED STATES OF AMERICA, AS REPRESENTED BY THE SECRETARY OF AGRICULTURE, Washington, DC (US)

(72) Inventors: Prabha Sundaravadivel, Allen, TX (US); Aryan Anand, Tyler, TX (US); Brian Ott, Leland, MS (US); Chase Patrick Brown, Marshall, TX (US); Theoren William Stroud, Bullard, TX (US)

(73) Assignees: BOARD OF REGENTS, THE UNIVERSITY OF TEXAS SYSTEM, Austin, TX (US); THE UNITED STATES OF AMERICA, AS REPRESENTED BY THE SECRETARY OF AGRICULTURE, Washington, DC (US)

(21) Appl. No.: 19/328,755

(22) Filed: Sep. 15, 2025

Related U.S. Application Data
(60) Provisional application No. 63/721,110, filed on Nov. 15, 2024.

(51) Int. Cl. G06V 10/82; G06N 3/08; G06T 7/10; G06V 10/141; G06V 10/25; G06V 20/70

(52) U.S. Cl. CPC G06V 10/82; G06N 3/08; G06T 7/10; G06V 10/141; G06V 10/25; G06V 20/70; G06T 2207/30242; G06V 2201/07

(57) ABSTRACT

A device for identifying fish in a water sample includes a light source configured to illuminate the sample within a container, a camera configured to capture an image of the sample, and a computing device configured to identify fish in the water sample from the image using one or more machine learning models. A computer-implemented method for training a neural network to count and classify fish at different stages of development within a water sample comprises collecting a two or more sets of digital images of water samples containing fish at two or more different stages of development, and training the neural network using the two or more sets of digital images to classify fish in an input digital image of a water sample as one of the stages of development of the two or more sets of digital images.

### CROSS REFERENCE TO RELATED APPLICATION

This application claims the benefit under 35 U.S.C. § 119(e) of the filing date of U.S. provisional patent application Ser. No. 63/721,110 filed Nov. 15, 2024, the disclosure of which is incorporated herein by reference.

### STATEMENT OF GOVERNMENTAL SUPPORT

This invention was made with U.S. Government support under new Cooperative Agreement (NACA): 58-6066-4-018 awarded by the U.S. Department of Agriculture. The U.S. Government has certain rights in this invention.

### TECHNICAL FIELD

Aspects of the present disclosure relate to a device and method for detecting fish using a machine learning model.

### BACKGROUND

Monitoring egg and fry populations is crucial for the success of commercial fish farms. By closely tracking these early life stages, farm managers can optimize breeding programs and ensure high survival rates. Additionally, understanding population dynamics helps in forecasting production levels and ensuring sustainable practices that can meet market demands. Effective monitoring contributes to the long-term viability and profitability of fish farming operations.

Conventional methods of calculating egg and fry populations are inaccurate and resource intensive. These methods often require an employee manually counting the number of fish eggs or fry in a sample. Alternatively, these methods may include estimating a population based on historic data alone. The reliance on historic performance, however, may not always account for changing variables such as environmental conditions or advancements in breeding techniques.

As such, there is a need for an accurate method to quickly identify and count the number of fish in a sample.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

A device as described herein is designed for detecting fish using a machine learning model. The device may include a camera configured to capture images of fish at different stages of development (e.g., egg or fry) in a petri dish. The images may be fed into a machine learning model to identify a class related to the fish and determine the number of fish in the petri dish. An estimated fish population may be extrapolated from the number of fish in the petri dish. Utilizing a machine learning model to determine a fish population in a sample is more accurate than manually counting and reduces processing time. It offers a significant advantage in hatcheries, where precise monitoring of egg and fry populations is crucial for optimizing breeding programs and ensuring high survival rates.

Aspects of the present disclosure relate to a device for identifying fish in a container. The device includes a base including a top surface and a light source. The light source is disposed under the top surface and is configured to light the container positioned on the top surface. The device includes a camera disposed above the top surface. The camera is configured to capture an image of a sample within the container. The device includes a computing device configured to receive the image from the camera and identify the fish in the container based on the image using one or more machine learning models.

In another aspect, a method is provided for identifying fish in a container. The method includes determining that the container is positioned on a top surface of a base. The method includes capturing an image of a sample within the container as a result of determining that the container is positioned on the base. The method includes identifying the fish in the container based on the image using one or more machine learning models.

Other features and characteristics of the subject matter of this disclosure, as well as the methods of operation, functions of related elements of structure and the combination of parts, and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

The accompanying drawings, which are incorporated herein and form part of the specification, illustrate various embodiments of the subject matter of this disclosure. In the drawings, like reference numbers indicate identical or functionally similar elements.

FIG. 1 is a top perspective view of a device for detecting fish at different stages of development.

FIG. 2A is a perspective view of a camera arm rail of a camera stand of the device.

FIG. 2B is a perspective view of a camera holder of the camera stand of the device.

FIG. 2C is a perspective view of a rail lock of the camera stand of the device.

FIG. 2D is a perspective view of a base of the device.

FIG. 2E is a perspective view of a bottom plate of the base.

FIG. 3A is a training image of a petri dish including fish samples.

FIG. 3B is an output image of a petri dish including fish samples.

FIG. 4A shows a front perspective view of a device for detecting fish.

FIG. 4B shows a top perspective view of the device of FIG. 4A.

FIG. 4C is a partial top view of the device of FIG. 4A.

FIG. 5 is a flow diagram of a method for identifying fish in a container.

FIG. 6 is a block diagram of an apparatus for identifying fish in a container.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

### Definitions

Unless defined otherwise, all terms of art, notations and other technical terms or terminology used herein have the same meaning as is commonly understood by one of ordinary skill in the art to which this disclosure belongs. All patents, applications, published applications and other publications referred to herein are incorporated by reference in their entirety. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

Unless otherwise indicated or the context suggests otherwise, as used herein, “a” or “an” means “at least one” or “one or more.”

References in the specification to “one embodiment,” “an embodiment,” a “further embodiment,” “an example,” “an exemplary embodiment,” “some aspects,” “a further aspect,” “aspects,” etc., indicate that the embodiment, example, or aspect described may include a particular feature, structure, or characteristic, but every embodiment encompassed by this disclosure may not necessarily include the particular feature, structure, or characteristic or combination thereof. Moreover, such phrases are not necessarily referring to the same embodiment, example, or aspect. Further, when a particular feature, structure, or characteristic is described in connection with an embodiment, such feature, structure, or characteristic is also a description in connection with other embodiments, examples, or aspects with which it is not incompatible, whether or not explicitly described.

This description may use various terms describing relative spatial arrangements and/or orientations or directions in describing the position and/or orientation of a component, apparatus, location, feature, or a portion thereof or direction of movement, force, or other dynamic action. Unless specifically stated, or otherwise dictated by the context of the description, such terms, including, without limitation, top, bottom, above, below, under, on top of, upper, lower, left, right, in front of, behind, beneath, next to, adjacent, between, horizontal, vertical, diagonal, longitudinal, transverse, radial, axial, clockwise, counter-clockwise, forward, backward, sideward, sideways, etc., are used for convenience in referring to such component, apparatus, location, feature, or a portion thereof or movement, force, or other dynamic action represented in the drawings and are not intended to be limiting.

Unless otherwise indicated, or the context suggests otherwise, terms used herein to describe a physical and/or spatial relationship between a first component, structure, or portion thereof and a second component, structure, or portion thereof, such as, attached, connected, fixed, joined, linked, coupled, or similar terms or variations of such terms, shall encompass both a direct relationship in which the first component, structure, or portion thereof is in direct contact with the second component, structure, or portion thereof or there are one or more intervening components, structures, or portions thereof between the first component, structure, or portion thereof and the second component, structure, or portion thereof.

Unless otherwise stated, any specific dimensions mentioned in this description are merely representative of an exemplary implementation of a device embodying aspects of the disclosure and are not intended to be limiting.

To the extent used herein, the terms “about” or “approximately” apply to all numeric values and terms indicating specific physical orientations or relationships such as horizontal, vertical, parallel, perpendicular, concentric, or similar terms, specified herein, whether or not explicitly indicated. This term generally refers to a range of numbers, orientations, and relationships that one of ordinary skill in the art would consider as a reasonable amount of deviation to the recited numeric values, orientations, and relationships (i.e., having the equivalent function or result) in the context of the present disclosure. For example, and not intended to be limiting, this term can be construed as including a deviation of ±10 percent of the given numeric value, orientation, or relationship, provided such a deviation does not alter the end function or result of the stated value, orientation, or relationship. Therefore, under some circumstances as would be appreciated by one of ordinary skill in the art a value of about or approximately 1% can be construed to be a range from 0.9% to 1.1%.

To the extent used herein, the term “adjacent” refers to being near (spatial proximity) or adjoining (physical contact). Adjacent objects or portions thereof can be spaced apart from one another or can be in actual or direct physical contact with one another. In some instances, adjacent objects or portions thereof can be coupled to one another or can be formed integrally with one another.

To the extent used herein, the terms “substantially” and “substantial” refer to a considerable degree or extent. When used in conjunction with, for example, an event, circumstance, characteristic, or property, the terms can refer to instances in which the event, circumstance, characteristic, or property occurs precisely as stated as well as instances in which the event, circumstance, characteristic, or property occurs to a close approximation, such as accounting for typical tolerance levels or variability of the embodiments described herein.

To the extent used herein, the terms “optional” and “optionally” or the term “may” (e.g., as in the phrase “may include,” “may comprise,” “may produce,” “may provide,” or similar phrases) mean that the subsequently described, component, structure, element, event, circumstance, characteristic, property, etc. may or may not be included or occur and that the description includes instances where the component, structure, element, event, circumstance, characteristic, property, etc. is included or occurs and instances in which it is not or does not.

To the extent used herein, the terms “first” and “second” preceding the name of an element (e.g., a component, apparatus, location, feature, or a portion thereof or a direction of movement, force, or other dynamic action) are used for identification purposes to distinguish between similar elements, and are not intended to necessarily imply order, nor are the terms “first” and “second” intended to preclude the inclusion of additional similar elements. Furthermore, use of the term “first” preceding the name of an element (e.g., a component, apparatus, location, feature, or a portion thereof or a direction of movement, force, or other dynamic action) does not necessarily imply or require that there be additional, e.g., “second,” “third,” etc., such element(s).

To the extent used herein, the terms or phrases “configured to,” “adapted to,” “operable to,” “constructed and arranged to,” and similar terms mean that the object of the term or phrases includes, constitutes, or otherwise encompasses the requisite structure(s), mechanism(s), arrangement(s), component(s), material(s), algorithm(s), circuit(s), programming, etc. to perform a specified function, task, or tasks or achieve a specified output or characteristic, either automatically or perpetually or selectively when called upon to do so.

All possible combinations of elements and components described in the specification or recited in the claims are contemplated and considered to be part of this disclosure. It should be appreciated that all combinations of the foregoing concepts and additional concepts discussed in greater detail herein (provided such concepts are not mutually inconsistent) are contemplated as being part of the unique subject matter described herein. In particular, all combinations of claimed subject matter appearing at the end of this disclosure are contemplated as being part of the inventive subject matter disclosed herein.

### Description

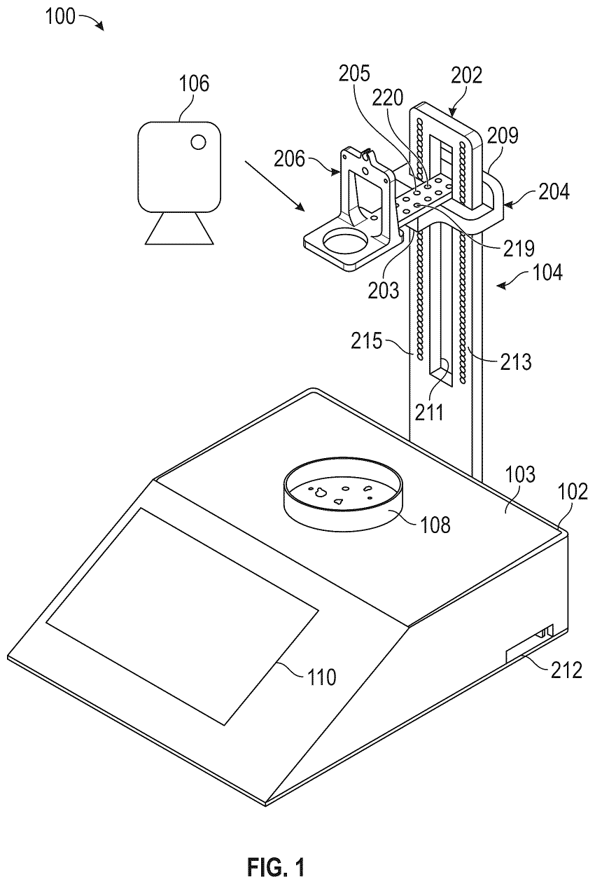

A device for detecting fish using a machine learning model (neural network) is shown in FIG. 1. In this context, “detecting fish” refers to detecting fish within a water sample at two or more different classes, or stages, of development, such as, eggs, sac-fry, and swim-up fry, and may also include the number of fish in a water sample. A database of annotated images of water samples containing fish at two or more different stages of development, such as fish eggs, sac fry, and swim-up fry, is integrated with advanced computer vision and artificial intelligence techniques to compare historical and real-time data, enabling accurate predictions of quantifications of samples. The algorithm may also embed metadata, such as, time, date, and the number of objects per observation, to calculate the weight of the sample.

In general, the device includes a well-lighted platform that can illuminate the items in a container containing a water sample as soon as the container is placed on the platform. The “items” of interest in the water sample that are illuminated are eggs, sac-fry, and swim-up fry. The container may be a petri dish, which may be transparent, semitransparent, or translucent. The device includes a smart camera that can count—or is in operable communication with a device that can count—the number of items in the water sample as soon as a petri dish is placed on the platform. The camera's focus can be adjusted as it can be zoomed in and out based on the size of the petri-dish. The device may include an on-board computer—or may be connected to a remote computer—that can run the software required for counting the number of items in an image of the water sample.

The device 100 may be embodied as a stand-alone intelligent monitoring device that autonomously quantifies fish eggs and fry in real-time. The device 100 includes a base 102, a camera stand, 104, and a smart camera 106. In this context, a “smart camera” refers to a digital camera for acquiring digital images that is operatively coupled with software executing an image recognition or image detection machine learning model (neural network) that is trained to detect, identify, classify, and/or count certain features in the acquired images. A non-limiting list of suitable digital cameras includes cameras produced by ELP, such as the ELP 4K USB Camera Module Autofocus with Microphone for Computer Mini USB2.0 Webcam Board 8 mp Industrial Lightburn Camera IMX415 PC Camera Audio Video Web Camera. A suitable camera may include high resolution (e.g., 4K 3840*2160), autofocus, and USB support. In some embodiments, the device 100 includes a durable, water-resistant casing, making it suitable for use in diverse aquatic environments.

A user may deposit a water sample suspected of containing fish into a container adapted for observing the fish with the smart camera 106 (an observation container), such as a petri dish 108, and place the petri dish 108 on the base 102 below the smart camera 106. The water sample may be obtained from a fish tank or pond. The device 100 may be configured (trained) to predict a number of fish in the water sample contained in the petri dish 108 and to predict a class associated with the fish. For example, the fish detected in the water sample may belong to one of the following classes: eggs, swim-up fry, and sac-fry. Eggs are un-hatched eggs deposited by spawning adult fish. Sac-fry are immobile fish hatched from eggs that receive nourishment from their yolk sac. Swim-up fry are fish that are ready to swim and feed. The fish may be catfish or any other species of fish.

The smart camera 106 may be supported on the camera stand 104 and may be configured—e.g., positioned, programmed, focused—to capture images of the water sample contained within the petri dish 108. The position of the smart camera 106 may be adjusted vertically up and down relative to the base 102 and the petri dish 108 and horizontally toward and away from the camera stand 104 by adjusting the camera stand 104. In some embodiments, the smart camera 106 may have an adjustable zoom feature. The smart camera 106 may be configured to adjust a focus on the smart camera 106 as it can be zoomed in and out based on the size of the petri-dish. In some embodiments, a top surface 103 of the base 102 may include a reference marker (e.g., a ruler or grid (not shown)). The smart camera 106 may use the reference marker for calibrating the position of the petri dish 108. The smart camera 106 may be positioned with respect to the petri dish and focused such that items in the water sample (eggs, sac-fry, and or swim-up fry) are individually discernible in an image produced by the smart camera 106 via processing software as described herein.

In some embodiments, the device 100 may be configured to detect when the petri dish 108 is placed upon the base 102, e.g., by the smart camera 106 detecting a petri dish image within its field of view or by other sensors or detectors provided on the device. In such embodiments, the device 102 may be configured to count the number of fish and may also be configured to classify the fish in the water sample as soon as the petri dish 108 containing a water sample, which may include eggs, sac-fry, and swim-up fry, is placed on the base 102.

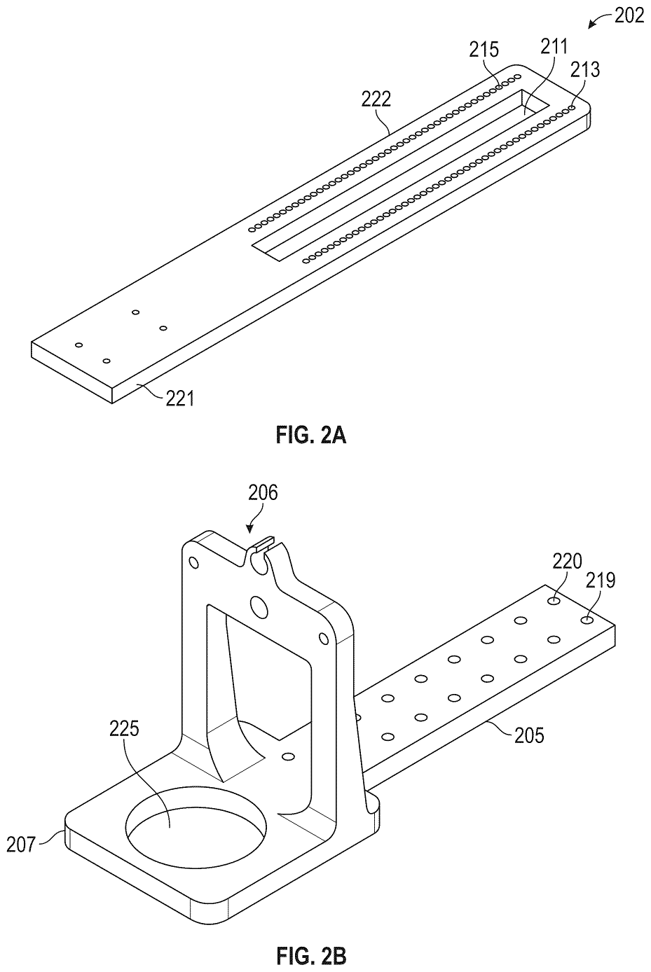

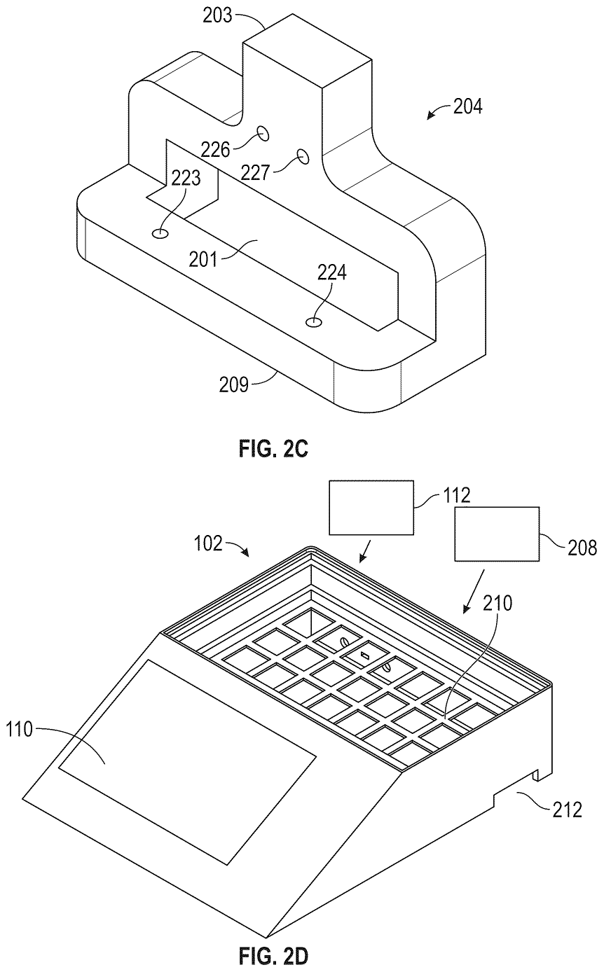

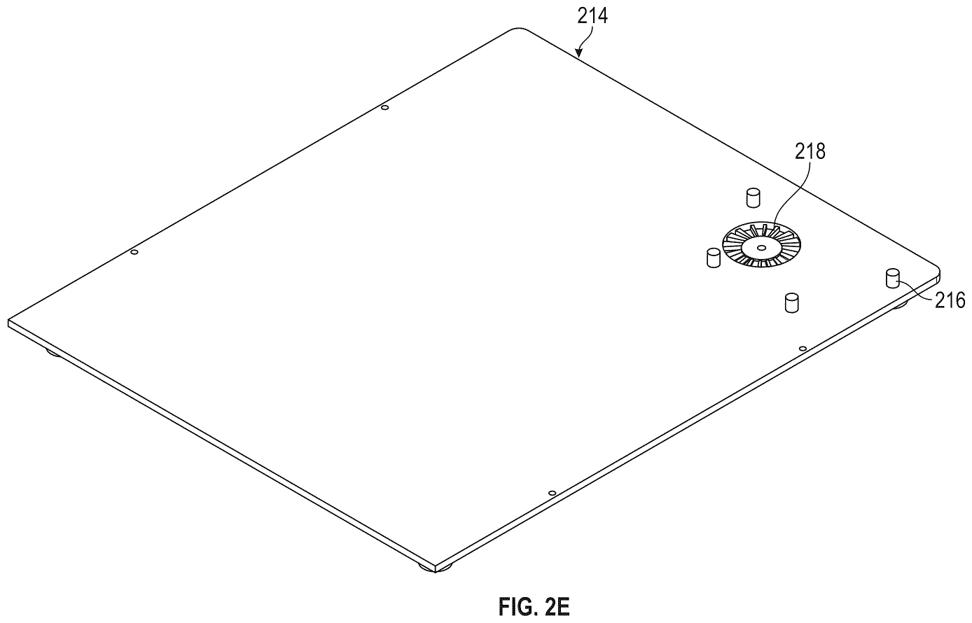

Components of the device 100 are shown in FIGS. 2A-2E. Referring to FIGS. 2A-2C, the camera stand 104 may include a camera arm rail 202 (FIG. 2A), a rail lock 204 (FIG. 2C), and a camera holder 206 (FIG. 2B). As shown in FIG. 2A, camera arm rail 202 includes a first portion 221 at one end of the rail 202 configured to be coupled to the base 102 and a second portion 222 at an opposite end of the rail 202 configured to be coupled to the camera holder 206 and the rail lock 204. The second portion 222 of camera arm rail 202 may include a first set of aligned holes 213, a second set of aligned holes 215, and a gap 211 positioned between the first set of holes 213 and the second set of holes 215. The rail lock 204 may be configured to interlock with the first and second set of holes 213, 215 of the camera arm rail 202.

As shown in FIG. 2C, rail lock 204 may have an opening 201 through which the camera arm rail 202 extends, a cross bar 209 and a support 203. In some embodiments, as shown in FIG. 1, rail lock 204 slides over the camera arm rail 202 with cam arm rail 202 extending through opening 201, cross bar 209 disposed on a back side of camera arm rail 202, and support 203 disposed on a front side of camera arm rail 202. The rail lock 204 may be configured to interlock with the camera arm rail 202 in a plurality of positions along the camera arm rail 202, each position being a different distance from the base 102. For example, a user may change the position of the rail lock 204 along the camera arm rail 202 to adjust the height of the smart camera 106. In one example, rail lock 204 is retained at a fixed position on the camera arm rail 202 by first and second pins (not shown) of rail lock 204 extending into a hole of each of the first and second sets of holes 213, 215, respectively, on a first (front) side of the camera arm rail 202 and associated holes 223, 224 formed in the cross bar 209 of rail lock 204 bearing against a second (back) side of the camera arm rail 202.

The camera holder 206 may be configured to interlock with the camera arm rail 202 and the rail lock 204. As shown in FIG. 2B, camera holder 206 includes a support bar 205 and a camera bracket 207. As shown in FIG. 1, support bar 205 of the camera holder 206 extends through the opening 201 of the rail lock 204 and is supported on the support 203 of the rail lock 204. Support bar 205 of the camera holder 206 extends through the gap 211 of the camera arm rail 202 and beneath the cross bar 209 of the rail lock 204. The smart camera 106 may be placed on the camera bracket 207 of the camera holder 206 such that a lens of the smart camera 106 is facing the top surface 103 of the base 102 and the petri dish 108, for which purpose a circular hole 225 may be formed in the camera bracket 207. With the support bar 205 resting on top of support 203 and beneath the cross bar 209 of the rail lock 204, the camera holder 206 is held in place by the weight of the camera bracket 207 and a camera supported on the camera bracket. Support bar 205 may include rows of aligned holes 219, 220 extending along the length thereof, and camera bracket 207 may held in a fixed lateral position with respect to rail lock 204 by a first pin (not shown) extending through one of holes 219 into a hole 226 formed in support 203 of rail lock 204 and a second pin (not shown) extending through one of holes 220 into a hole 227 formed in support 203 of rail lock 204 to secure the camera holder 206 at a desired lateral spacing with respect to the camera arm rail 202.

Referring to FIGS. 1 and 2D, the base 102 may include a light source 208, a light source tray 210, a vent 212, a touch screen or other user interface 110, and a computing device 112. The light source 208 may be positioned under the top surface 103 of the base 102 and on the light source tray 210. The light source 208 may be configured to illuminate the samples in the petri dish 108 from beneath the petri dish 108, for which purpose the petri dish 108 or other observation container is transparent, semitransparent, or translucent. The light source 208 may be a light-emitting diode (LED) light or other suitable light source and may have an adjustable light intensity. The petri dish 108 may be positioned on the top surface 103 of base 102, and the top surface 103 may be transparent, semitransparent, or translucent to allow light from the light source 208 to transmit through the top surface 103 to illuminate the petri dish 108 supported thereby. The device 102 may include a switch, which may be incorporated into the touch screen 110, configured to control the light source 208 (e.g., on/off, intensity level, etc.). In some embodiments, the light source 208 may be configured to turn on automatically as a result of the petri dish 108 being placed on the base 102, e.g., via a contact switch or an optical detection switch on or near the top surface 103 of the base 102 or the light source tray 210 or via detection of the petri dish 108 by the smart camera 106. The vent 212 is configured to circulate air within the base 102 and/or exhaust hot air from the base 102. In some embodiments, the vent 212 may be disposed adjacent to the computing device 112, and a fan (not shown) may be placed within the base 102 in front of the vent 212 to facilitate air circulation within the base 102.

The touch screen 110 may be disposed on a front portion of the base 102 and may display a graphical user interface to enable a user to interact with the device 102. A front portion of the base 102 may be slanted for ergonomic comfort and convenience and include a groove configured to hold the touch screen 110. A user may interact with the device 102 using the touch screen 110. For example, a user may begin a scan, view the results of a scan, enter sample details, and/or transmit the results to another device using the touch screen 110. As another example, once a user logins to the device 102 using the touch screen 110 and puts a petri dish under the smart camera 106, the touch screen 110 may display information on the number of eggs, sac fry, and swim-up fry in the petri dish.

Computing device 112 may be disposed within the base 102, or the computing device 112 may be remote from the base and connected—wired or wirelessly—to the camera 106, the light source 208, and the touch screen 110. The computing device 112 may be configured to receive the captured images from the smart camera 106 and process the images using one or more machine learning models. In some embodiments, the computing device 112 may transmit the captured images to another computing device and the other computing device may be configured to process the captured images using one or more machine learning models as described herein.

Referring to FIG. 2E, base 102 may include a bottom plate 214 having screw inserts 216 and a thermal air vent inlet 218. The computing device 112 may be secured by screws (not shown) to the screw inserts 216 and disposed above the air vent inlet 218. The thermal air vent inlet 218 may be configured to provide cooling air for the computing device 112.

One or more machine learning models may operate on the computing device 112 (i.e., computing device may be programmed to execute one or more machine learning models) and may be configured to detect fish in the images of the petri dish 108 produced by the smart camera 106. Example machine learning models include a YOLO v8 nano model and/or an OpenCV model or other similarly capable models. The one or more machine learning models may have been trained with images (e.g., thousands) of fish within a corresponding class. For example, the training data may include a first set of images of a water samples including eggs in the samples, a second set of images of water samples including swim-up fry in the samples, and a third set of images of water samples including sac fry in the samples, and the machine learning model is “taught” to recognize eggs, swim-up fry, and sac fry in a sample image. Each set of images of the training data may include images having parameters with one or more of the following augmentations: saturation adjustments, brightness adjustments, hue adjustments, added noise, mirroring, rotations, and scaling.

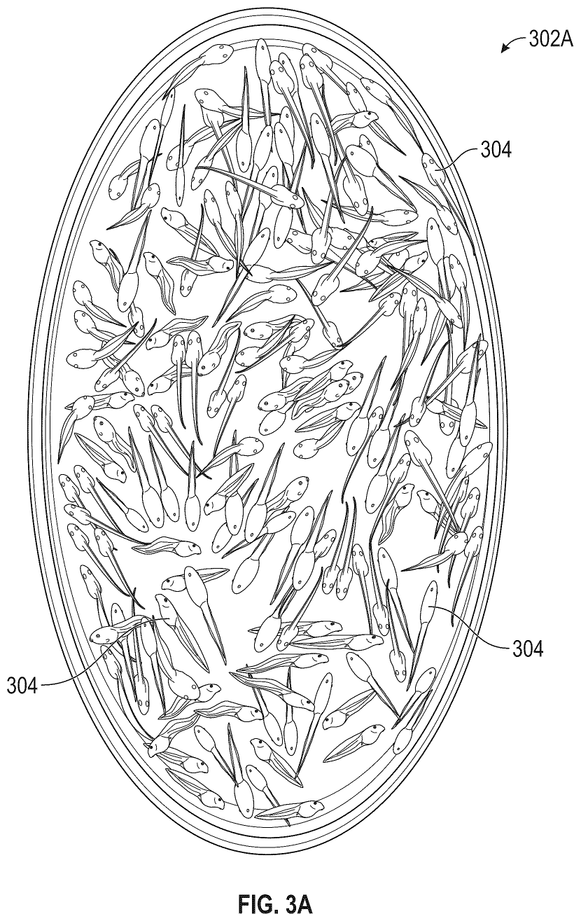

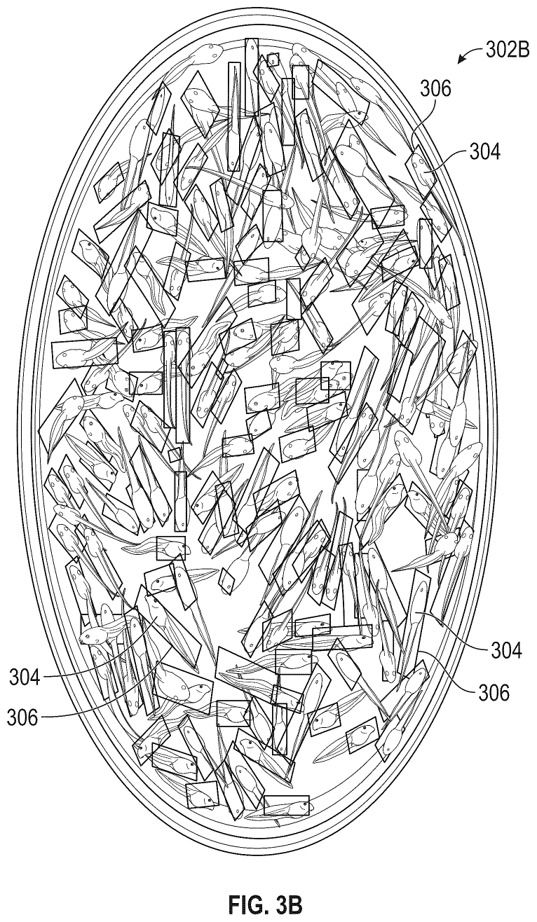

An example of a training image 302A of a sample contained in a petri dish is shown in FIG. 3A. Multiple training images, such as training image 302A, may be fed into the one or more machine learning models for training the one or more machine learning models. For example, the input image may include a plurality of objects 304 (sac fry, three of which are labeled in FIG. 3A) in a petri dish as shown. In some embodiments, training image 302A may include labels for individual objects by segmenting each object in the image and capturing features that are relevant for distinguishing the object. The labels may include a class of the object, such as egg, sac fry, or swim-up fry. The features of each object (e.g., size and shape) may be used to train the one or more machine learning models to detect objects—eggs, sac fry, or swim-up fry—within an image to determine a class associated with the detected object based on one or more distinguishing features. For example, the one or more machine learning models may be trained to recognize that a that a particular class (e.g., eggs, swim-up fry, and sac-fry) is associated with a first set of features, such as particular sizes and shapes that are unique to eggs, swim-up fry, and sac-fry, respectively.

The one or more machine learning models may be configured to detect fish in a sample and identify a class of the fish (e.g., eggs, swim-up fry, and sac-fry). An output image 302B of the one or more machine learning models is shown in FIG. 3B. The one or more machine learning models may identify one or more objects 304 in an input image. For each identified object 304, the one or more machine learning models may determine whether the object 304 is a fish belonging to a particular class. The one or more machine learning models may determine that object 304 belongs to a class (e.g., eggs, swim-up fry, and sac-fry) based on one or more features of the detected object. In some embodiments, the one or more machine learning models may determine that object 304 belongs to a class using one or more features of object 304. As shown in FIG. 3B, the one or more machine learning models may output an output image 302B in which each object 304 that is determined to be a fish, (i.e., egg, swim-up fry, or sac fry) may include a bounding box 306 displayed around the object.

In some embodiments, the one or more machine learning models may output a confidence score for each detected object. The confidence score may be based on one or more features of the detected object. The computing device 112 may compare the confidence score to a threshold. As a result of the confidence score being above the threshold, the computing device 112 may determine the detected object is a fish and include a bounding box over the detected object. In some embodiments, the threshold may be based on class. For example, the threshold may be s 50%, 25%, and 25% for eggs, sac fry, and swim-up fry, respectively. In some embodiments, the output of the computing device 112 may include additional information, such as, a number of fish in the image, a time and date the image was captured, and an estimated weight of the petri dish including the water sample as well as the weight of the eggs/swim-up fry/sac-fry from the size of the items identified.

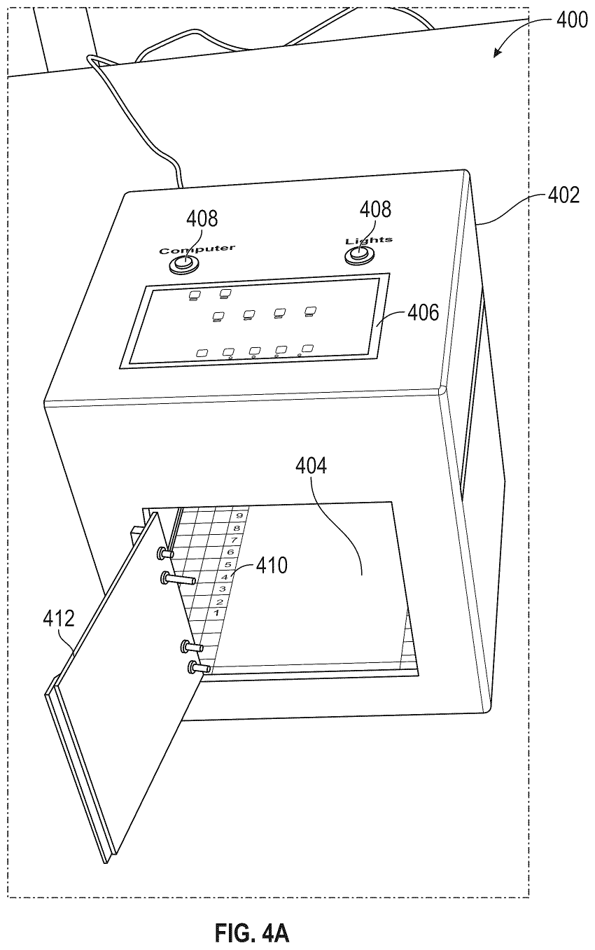

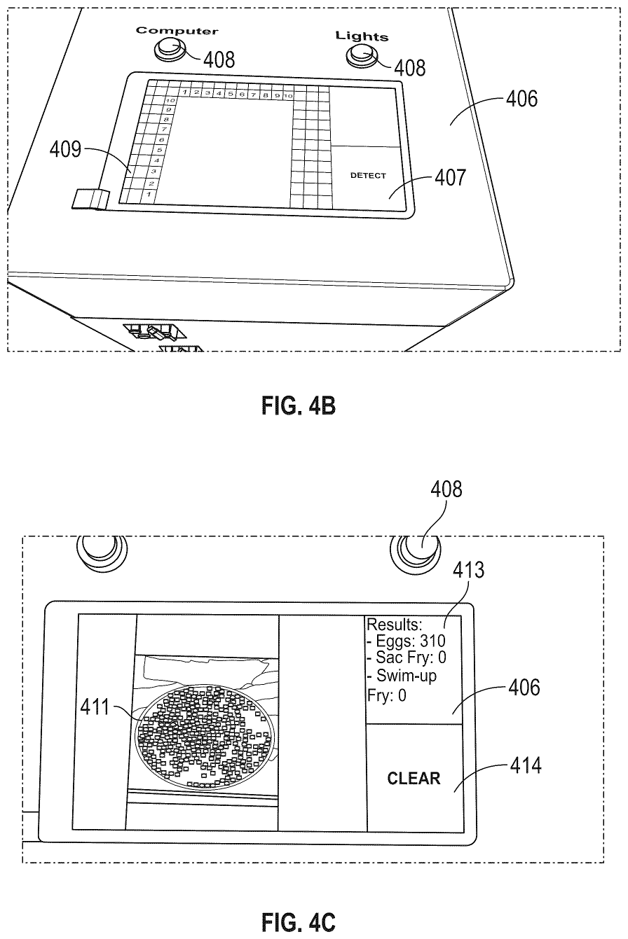

An alternative embodiment of a device 400 for detecting fish using a machine learning model is shown in FIGS. 4A-4C. The device 400 may be embodied as a stand-alone intelligent monitoring device that autonomously quantifies fish eggs and fry in real-time. The device 400 includes a housing 402, a platform 404 inside the housing, a touch screen or other user interface 406, and one or more operating switches, such as push buttons 408. The housing 402 includes an interior space, an outer surface, and an opening with a door 412 to thereby provide an enclosed interior space. The housing 402 may include a durable, water-resistant casing, making it suitable for use in diverse aquatic environments.

The device 400 may include a light source (not shown) within housing 402 and configured to light a petri dish supported on platform 404. The light source, which may comprise one or more LEDs or other suitable light source(s) may be disposed above and/or below the platform 404. If the light source is located above the platform 404, platform 404 may have a light, reflective color (e.g., white), and if the light source is located below the platform 404, the platform is transparent, semitransparent, or translucent. The device 400 may include a smart camera (not shown), similar to smart camera 106 described herein, disposed within the interior space of the housing 402. The smart camera may be disposed above the platform 404 and may be configured to capture images of a petri dish positioned on the platform 404. The platform 404 may include a reference 410. In some embodiments, the reference 410 may be a grid. The smart camera may use the reference 410 to adjust one or more parameters of the smart camera. For example, the reference 410 may be used to measure the size of the petri dish, and reference 410 may be used to facilitate aligning light convergence according to the position of the petri dish. The enclosed housing promotes improved image quality, e.g., improved image resolution, over a device lacking a housing by blocking ambient light from the camera.

A user may identify fish in a petri dish by placing the petri dish on the platform 404. The images of the water sample within the petri dish may be transmitted to a computing device disposed within the device 400 and/or to another computing device that is remote from device 400. The computing device may include, i.e., be programed to execute, one or more machine learning models trained and configured to process the captured images as described herein. The one or more machine learning models may determine a number of fish in the image, such as image 302A in FIG. 3A, a class associated with the detected fish (eggs, sac-fry, or swim-up fry), and may generate an output image including bounding boxes over each identified object, such as image 302B in FIG. 3B.

Referring to FIGS. 4B and 4C, the touch screen 406 and the one or more push buttons 408 may be disposed on a top surface of the housing 402. As shown in FIG. 4B, the touch screen 406 may display a graphical user interface including a view of the smart camera field of view 409 and a button 407 (labeled “Detect”) to begin a scan. After scanning a petri dish, as shown in FIG. 4C, the graphical user interface of the touch screen 406 may display the results of the scan (shown on the left), such as an image of the water sample within the petri dish with bounding boxes around detected objects, data/results 413 associated with the scan (shown on the top right) which may identify classification and number of objects detected (Results: —Eggs: 310, —Sac Fry: 0, —Swim-Up Fry: 0), and a “Clear” button 414 to clear the results (shown on the bottom right). In some embodiments, the one or more push buttons 408 may include a first push button configured to activate the computing device of the device 402 and a second push button to turn on/off the light source.

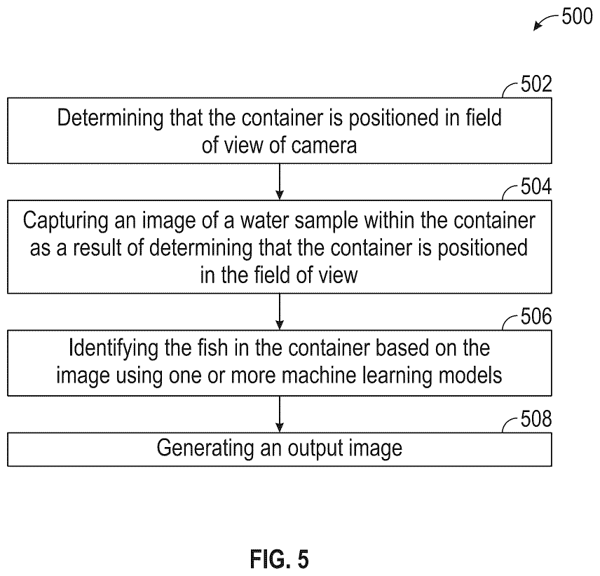

FIG. 5 is a flow diagram of a method 500, according to some embodiments, for identifying fish in a container. Method 500 may be performed with or used in conjunction with any of the computer systems, devices, mechanisms, elements, or components disclosed herein, among other devices, including computing device 600, described below. Method 500 may be coded and stored as a computer-executable control algorithm for controlling the operation(s) of one or more of the computer systems, devices, mechanisms, elements, or components disclosed herein, among other devices. In various embodiments, some of the method steps shown may be performed concurrently, in a different order than shown, or may be omitted. Additional method steps may also be performed as desired. Flow begins at step 502.

Step 502 includes determining that the container (e.g., petri dish) is positioned in a field of view of the smart camera, e.g. on top surface 103 of base 102 of device 100 or on support platform 404 of device 400.

Step 504 includes capturing an image of a water sample within the container as a result of determining that the container is positioned in the field of view.

Step 506 includes transferring the image to a computing device and identifying the fish in the container based on the image using one or more machine learning models executed by the computing device.

In some embodiments, step 504 of method 500 includes providing light using a light source, e.g., light source 208 of device 100, which may be disposed under the top surface 103 of the base 102 or the light source of device 400, which may be disposed above and/or below support platform 404. In some embodiments, identifying fish in the container (step 506) includes determining a number of fish in the container. In some embodiments, identifying fish in the container (step 506) includes determining a class associated with the fish in the container, such as eggs, sac-fry, or swim-up fry.

In some embodiments, identifying fish in the container (step 506) includes: detecting an object within the container; obtaining a confidence score associated with the detected object; and comparing the confidence score to a threshold. In some embodiments, the threshold is based on a class of the detected object.

In one example, step 506 is performed by using OpenCV to read the input images of water samples, which then gave the data as a computer vision (CV) image to a YOLO model to produce a list of resultant bounding boxes. These boxes were then filtered using a per-class confidence threshold of 50%, 25%, and 25% for eggs, sac fry, and swim-up fry, respectively. These then were used to annotate the images using OpenCV to produce output images.

In some embodiments, method 500 includes step 508, generating an output image. The output image includes a bounding box displayed over each fish in the container. In some embodiments, the output image includes metadata, and the metadata includes a data stamp, a time stamp, and an estimated weight of the container. In some embodiments, method 500 includes receiving an input from a touch screen. In some embodiments, method 500 includes adjusting one or more parameters of a camera based on a position of the container and a reference mark, such as reference mark 410 of device 400.

In some embodiments, method 500 includes, prior to step 502, training the one or more machine learning models using on a set of training images. In some embodiments, method 500 includes applying an augmentation to an image of the set of training images. In some embodiments, an image of the set of training images includes an object, and the object includes a classification label.

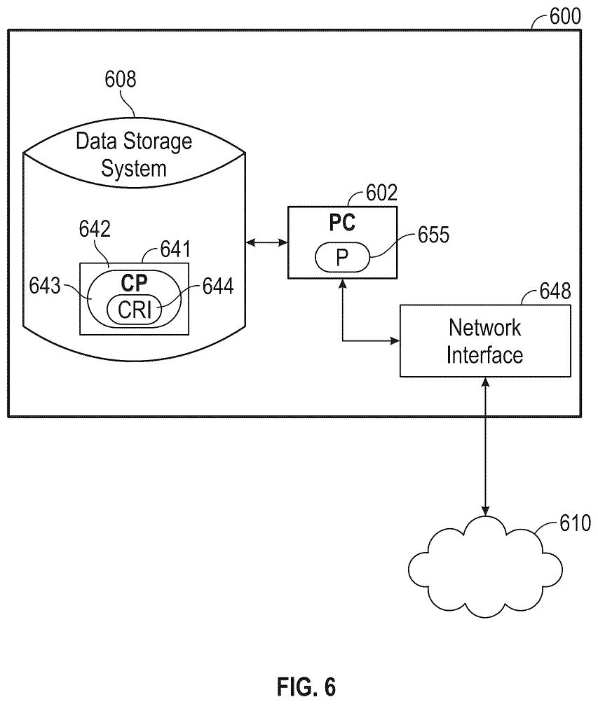

FIG. 6 is a block diagram of a computing device 600 according to some embodiments. Computing device 600 (e.g., computing device 112 of device 100 or the computing device of device 400) performs the methods and is included in all embodiments described above. As shown in FIG. 6, computing device 600 may comprise: processing circuitry (PC) 602, which may include one or more processors (P) 655 (e.g., a general purpose microprocessor and/or one or more other processors, such as an application specific integrated circuit (ASIC), field-programmable gate arrays (FPGAs), and the like); a network interface 648 for enabling the apparatus to transmit data to and receive data from other devices connected to a network 610 (e.g., an Internet Protocol (IP) network such as the Internet) to which network interface 648 is connected; and a local storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes the apparatus to perform steps described herein (e.g., steps described herein with reference to a method for identifying fish, such as method 500). In other embodiments, the apparatus may be configured to perform steps described herein without the need for code. That is, for example, PC 602 may consist merely of one or more ASICs. Hence, the features of the embodiments described herein may be implemented in hardware and/or software.

EMBODIMENTS—aspects of the disclosure are summarized in the following enumerated embodiments, which are not intended to be claims.
Embodiment A1. A device for identifying fish in a water sample held in a container, the device comprising a base comprising a top surface on which the container is supported, a light source configured to illuminate the container positioned on the top surface, a camera configured to capture an image of the water sample within the container, and a computing device configured to receive the image from the camera and to identify the fish in the water sample based on the image using one or more machine learning models.
Embodiment A2. The device of embodiment A1, wherein the light source is disposed under the top surface and/or the camera is disposed above the top surface.
Embodiment A3. The device of embodiment A1 or A2, wherein to identify fish in the water sample comprises determining a number of fish in the water sample.
Embodiment A4. The device of any one of embodiments A1 to A4, wherein to identify fish in the water sample comprises classifying the fish in the water sample according to a stage of development of the fish.
Embodiment A5. The device of embodiment A4, wherein the stage of development is eggs, sac-fry, or swim-up fry.
Embodiment A6. The device of embodiment A1, wherein to identify fish in the water sample comprises: detecting an object within the image; obtaining a confidence score associated with the object; and comparing the confidence score to a threshold.
Embodiment A7. The device of embodiment A6, wherein the threshold is based on a stage of development of the fish in the water sample.
Embodiment A8. The device of any one of embodiments A1 to A7, wherein the computing device is configured to determine that the container is placed in a field of view of the camera; and the camera is configured to capture the image as a result of determining that the container was placed in the field of view.
Embodiment A9. The device of any one of embodiments A1 to A8, wherein the computing device is configured to generate an output image, and the output image includes a bounding box displayed over each fish in the image.
Embodiment A10. The device of embodiment A9, wherein the output image comprises metadata, and the metadata comprises one or more of a data stamp, a time stamp, and an estimated weight of the container.
Embodiment A11. The device of any one of embodiments A1 to A10, wherein the device comprises a touch screen.
Embodiment A12. The device of any one of embodiments A1 to A11, wherein the device comprises a housing, and wherein the base, the camera, and the computing device are disposed within the housing.
Embodiment A13. The device of any one of embodiments A1 to A12, wherein the base comprises a reference mark on the top surface, and the camera is configure to adjust one or more parameters based on a position of the container with respect to the reference mark.
Embodiment B1. A method for identifying fish in a water sample within a container, the method comprising: determining that the container is positioned in a field of view of a camera; capturing an image of the water sample within the container with the camera as a result of determining that the container is positioned in the field of view; and identifying the fish in the container based on the image using one or more machine learning models.
Embodiment B2. The method of embodiment B1, further comprising illuminating the water sample using a light source, wherein the light source is disposed above and/or below a surface supporting the container.
Embodiment B3. The method of embodiment B1 or B2, wherein identifying fish in the water sample comprises determining a number of fish in the water sample.
Embodiment B4. The method of any one of embodiments B1 to B3, wherein identifying fish in the container comprises classifying the fish in the water sample according to a stage of development of the fish.
Embodiment B5. The method of embodiment B4, wherein the stage of development is eggs, swim-up fry, or sac-fry.
Embodiment B6. The method of embodiment B1, wherein identifying fish in the container comprises: detecting an object within the container; obtaining a confidence score associated with the object; and comparing the confidence score to a threshold.
Embodiment B7. The method of embodiment B6, wherein the threshold is based on a stage of development of the fish in the water sample.
Embodiment B8. The method of any one of embodiments B1 to B7, further comprising generating an output image, wherein the output image includes a bounding box displayed over each fish in the image.
Embodiment B9. The method of embodiment B1, wherein the output image comprises metadata, and the metadata comprises one or more of a data stamp, a time stamp, and an estimated weight of the container.
Embodiment B10. The method of any one of embodiments B1 to B9, further comprising: adjusting one or more parameters of the camera based on a position of the container and a reference mark on a surface supporting the container.
Embodiment B11. The method of any one of embodiments B1 to B10, further comprising: preparing a set of training images for training the one or more machine learning models by: identifying a plurality of objects in each image of the set of training images; segmenting each image based on the plurality of objects, wherein each segment of an image comprises an object of the plurality of objects and one or more identifiable features associated with the object; and applying a label to each segment of each image of the set of training images, wherein the label comprises one of at least two stages of development of fish in the training images; and using the set of training images to train the one or more machine learning models to detect objects in the image of the water sample based on the one or more identifiable features and to classify the detected object as one of the at least two stages of development of the fish.
Embodiment B12. The method of embodiment B11, wherein the at least two stages of development comprise eggs, sac fry, and swim-up fry.
Embodiment B13. The method of embodiment B12, wherein preparing the set of training images comprises: applying an augmentation to an image of the set of training images, wherein the augmentation comprises at least one of saturation adjustments, brightness adjustments, hue adjustments, added noise, mirroring, rotations, and scaling.
Embodiment C1. A method for assessing fish development in a sample, the method comprising: preparing a set of training images for training one or more machine learning models by: identifying a plurality of objects in each image of the set of training images; segmenting each image based on the plurality of objects, wherein each segment of an image comprises an object of the plurality of objects and one or more identifiable features associated with the object; and applying a label to each segment of each image of the set of training images, wherein the label comprises one of at least two stages of development of fish in the training images; using the set of training images to train the one or more machine learning models to detect objects in a sample based on the one or more identifiable features and to classify each detected object as a fish egg, a sac fry, or a swim-up fry; placing a sample in a container; obtaining an image of the sample in the container; and detecting any objects in the image of the sample based on the one or more identifiable features using the one or more machine learning models, classify each detected object as one of the at least two stages of development of the fish, and determining a number of objects in the sample.
Embodiment C2. The method of embodiment C1, wherein the at least two stages of development comprise eggs, sac fry, and swim-up fry.
Embodiment D1. A computer-implemented method for training a neural network to count and classify fish at different stages of development within a water sample, the method comprising: collecting a first set of digital images of water samples containing fish at a first stage of development; collecting a second set of digital images of water samples containing fish at a second stage of development different from the first stage of development; and training the neural network using the first and second sets of digital images to classify fish in an input digital image of a water sample as one of the first stage of development or the second stage of development.
Embodiment D2. The computer-implemented method of embodiment D1, wherein the first stage of development is eggs and the second stage of development is one of sac fry and swim-up fry.
Embodiment D3. The computer-implemented method of embodiment D1, further comprising collecting a third set of digital images of water samples containing fish at a third stage of development different from the first stage of development and the second stage of development; and further training the neural network using the third set of digital images to classify fish in an input digital image of a water sample as one of the first stage of development, the second stage of development, or the third stage of development.
Embodiment D4. The computer-implemented method of embodiment D3, wherein the first stage of development is eggs, the second stage of development is sac fry, and the third stage of development is swim-up fry.

While various embodiments of the present disclosure are described herein, it should be understood that they have been presented by way of example only, and not limitation. Thus, the breadth and scope of the present disclosure should not be limited by any of the above-described exemplary embodiments. Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any combination of the above-described elements in all possible variations thereof is encompassed by the disclosure unless otherwise indicated herein or otherwise clearly contradicted by context.

All possible combinations of elements and components described in the specification or recited in the claims are contemplated and considered to be part of this disclosure. It should be appreciated that all combinations of the foregoing concepts and additional concepts discussed in greater detail herein (provided such concepts are not mutually inconsistent) are contemplated as being part of the inventive subject matter described herein. In particular, all combinations of claimed subject matter appearing at the end of this disclosure are contemplated as being part of the inventive subject matter disclosed herein.

1. A device for identifying fish in a water sample held in a container, the device comprising:
a base comprising a top surface on which the container is supported;
a light source configured to illuminate the container positioned on the top surface;
a camera configured to capture an image of the water sample within the container; and
a computing device configured to receive the image from the camera and to identify the fish in the water sample based on the image using one or more machine learning models.

2. The device of claim 1, wherein the light source is disposed under the top surface and/or the camera is disposed above the top surface.

3. The device of claim 1, wherein the computing device is configured to identify fish in the water sample by at least one of determining a number of fish in the water sample and classifying the fish in the water sample according to a stage of development of the fish.

4. The device of claim 3, wherein the computing device is configured to identify fish in the water sample by classifying the fish in the water sample according to a stage of development of the fish, and wherein the stage of development is eggs, sac-fry, or swim-up fry.

5. The device of claim 1, wherein the computing device is configured to determine that the container is placed in a field of view of the camera, and the camera is configured to capture the image as a result of determining that the container was placed in the field of view.

6. The device of claim 1, wherein the computing device is configured to generate an output image, and wherein the output image includes a bounding box displayed over each fish in the image.

7. The device of claim 6, wherein the output image comprises metadata, and wherein the metadata comprises one or more of a data stamp, a time stamp, and an estimated weight of the container.

8. A method for identifying fish in a water sample within a container, the method comprising:
determining that the container is positioned in a field of view of a camera;
capturing an image of the water sample within the container with the camera as a result of determining that the container is positioned in the field of view; and
identifying the fish in the container based on the image using one or more machine learning models.

9. The method of claim 8, further comprising illuminating the water sample using a light source, wherein the light source is disposed above and/or below a surface supporting the container.

10. The method of claim 8, wherein identifying fish in the water sample comprises determining a number of fish in the water sample.

11. The method of claim 8, wherein identifying fish in the container comprises classifying the fish in the water sample according to a stage of development of the fish.

12. The method of claim 11, wherein the stage of development is eggs, swim-up fry, or sac-fry.

13. The method of claim 8, further comprising generating an output image, wherein the output image includes a bounding box displayed over each fish in the image.

14. The method of claim 8, further comprising:
preparing a set of training images for training the one or more machine learning models by:
identifying a plurality of objects in each image of the set of training images;
segmenting each image based on the plurality of objects, wherein each segment of an image comprises an object of the plurality of objects and one or more identifiable features associated with the object; and
applying a label to each segment of each image of the set of training images, wherein the label comprises one of at least two stages of development of fish in the training images; and
using the set of training images to train the one or more machine learning models to detect objects in the image of the water sample based on the one or more identifiable features and to classify the detected object as one of the at least two stages of development of the fish.

15. The method of claim 14, wherein the at least two stages of development comprise eggs, sac fry, and swim-up fry.

16. The method of claim 15, wherein preparing the set of training images comprises: applying an augmentation to an image of the set of training images, wherein the augmentation comprises at least one of saturation adjustments, brightness adjustments, hue adjustments, added noise, mirroring, rotations, and scaling.

17. A computer-implemented method for training a neural network to count and classify fish at different stages of development within a water sample, the method comprising:
collecting a first set of digital images of water samples containing fish at a first stage of development;
collecting one or more additional sets of digital images of water samples, wherein the digital images of each additional set contains fish at a different stage of development that is also different from the first stage of development; and
training the neural network using the first and additional sets of digital images to classify fish in an input digital image of a water sample as one of the stages of development of the fish in the first and additional sets of digital images.

18. The computer-implemented method of claim 17, wherein the first stage of development is eggs, and wherein the one or more additional sets of digital images of water samples comprise a second set of digital images of water samples containing fish at a second stage of development, and wherein the second stage of development is one of sac fry and swim-up fry.

19. The computer-implemented method of claim 17, wherein the one or more additional sets of digital images of water samples comprise a second set of digital images of water samples containing fish at a second stage of development different from the first stage of development and a third set of digital images of water samples containing fish at a third stage of development different from the first stage of development and the second stage of development.

20. The computer-implemented method of claim 19, wherein the first stage of development is eggs, the second stage of development is sac fry, and the third stage of development is swim-up fry.
